(19) United States
(12) Patent Application Publication
(10) Pub. No.: US 2022/0366483 A1
(43) Pub. Date: Nov. 17, 2022

(54) NEGOTIATION METHOD INCLUDING ELICITATION AND SYSTEM FOR IMPLEMENTING

(71) Applicant: NEC Corporation, Tokyo (JP)

(72) Inventors: Yasser Farouk Othman MOHAMMAD, Tokyo (JP); Kotone NINAGAWA, Tokyo (JP)

(21) Appl. No.: 17/388,004

(22) Filed: Jul. 28, 2021

Related U.S. Application Data
(60) Provisional application No. 63/187,951, filed on May 13, 2021.

(51) Int. Cl. G06Q 30/08; G06Q 30/02

(52) U.S. Cl. CPC G06Q 30/08; G06Q 30/0202

(57) ABSTRACT

A system includes a non-transitory computer readable medium configured to store instructions. The system further includes a processor connected to the non-transitory computer readable medium. The processor is configured to receive information for a user utility function (Ufun) having uncertainty. The processor is configured to generate an offer in a negotiation based on the user Ufun. The processor is configured to determine whether additional information should be requested from a user. The processor is configured to identify a query to obtain the additional information in response to a determination that additional information should be requested. The processor is configured to determine a value of information (VOI) value for the identified query. The processor is configured to send the identified query to the user in response to the VOI value being greater than the interruption threshold.

### PRIORITY CLAIM AND CROSS-REFERENCE

This application claims priority to U.S. Provisional Application No. 63/187,951, filed May 13, 2021, the entire contents of which are hereby incorporated by reference in their entirety.

### BACKGROUND

As commerce using the Internet has increased, autonomous negotiations have also increased. Autonomous negotiation utilizes artificial intelligence (AI) in place of human negotiators in order to attempt to reach agreements between parties. AI is used to evaluate an offer from an opponent and then determine a response to the offer. In some instances, the response is a counter-offer. In some instances, the response is acceptance of the offer. In some instances, the response is to end the negotiation.

In some approaches, an AI negotiator is fully trained with user preferences and priorities prior to beginning of a negotiation. In some approaches, an AI negotiator includes some minor uncertainty regarding user preferences and priorities at the beginning of a negotiation. In some approaches, the AI negotiator is able to submit a query to the user in order to reduce uncertainty of user preferences and priorities. However, the query merely inquires about how valuable a specific parameter is to the user without asking a user preference between options.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a schematic view of a negotiation in accordance with some embodiments.

FIG. 2 is a schematic view of a system for determining whether to elicit information from a user in accordance with some embodiments.

FIG. 3 is a flowchart of a method of negotiating in accordance with some embodiments.

FIG. 4 is a block diagram of a system for implementing a negotiation in accordance with some embodiments.

### DETAILED DESCRIPTION

The following disclosure provides many different embodiments, or examples, for implementing different features of the provided subject matter. Specific examples of components, values, operations, materials, arrangements, or the like, are described below to simplify the present disclosure. These are, of course, merely examples and are not intended to be limiting. Other components, values, operations, materials, arrangements, or the like, are contemplated. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

A utility function (Ufun) describes user preferences and priorities is a time consuming process. As a number of parameters in a negotiate increases, the number of variations in an offer increases exponentially. In order for an artificial intelligence (AI) negotiator to have a complete or nearly complete Ufun, the user will be requested to enter large amount of data or answer a large number of questions. In this description, a complete Ufun is a Ufun with little or no uncertainty, i.e., all user preferences and priorities are known. This process consumes a large amount of the user's time and increases user frustration with the AI negotiator.

Alternatively, in some instances, the AI negotiator will run numerous simulated negotiations in order to generate a complete or nearly complete Ufun based on some initial inputs received from the user. Completing numerous simulated negotiations consumes significant amounts of computational time and resources. Considering a number of different variations and ranking outcomes to provide feedback to the AI negotiator in order to complete the Ufun reduces the usability of the AI negotiator in time sensitive negotiations or negotiations that introduce previously unconsidered parameters.

In the approaches described above, failure to provide a complete or nearly complete Ufun causes poor negotiation results. According to information known to the inventors, an estimated 15% of money is lost during negotiations as a result of failure to consider all options.

In order to help improve negotiation results while at the same time reducing time consuming completion of Ufuns, the current disclosure includes a method of AI negotiation in which few initial inputs from a user are combined with an ability to elicit input from a user during a negotiation. By using few initial inputs, the user is not requested to answer a large number of queries and numerous simulated negotiations are avoided. The reduced queries to the user and reduced or avoided simulated negotiations minimizes the time used to create a usable AI negotiator. In some embodiments of the current disclosure, no simulated negotiations are performed prior to negotiating against an opponent. The reduced queries and simulated negotiations also reduces an amount of resources consumed to develop the AI negotiator.

Using the method and system of the current disclosure also helps the AI negotiator to handle negotiations which include previously unconsidered parameters. As a result, the AI negotiator has increased utility.

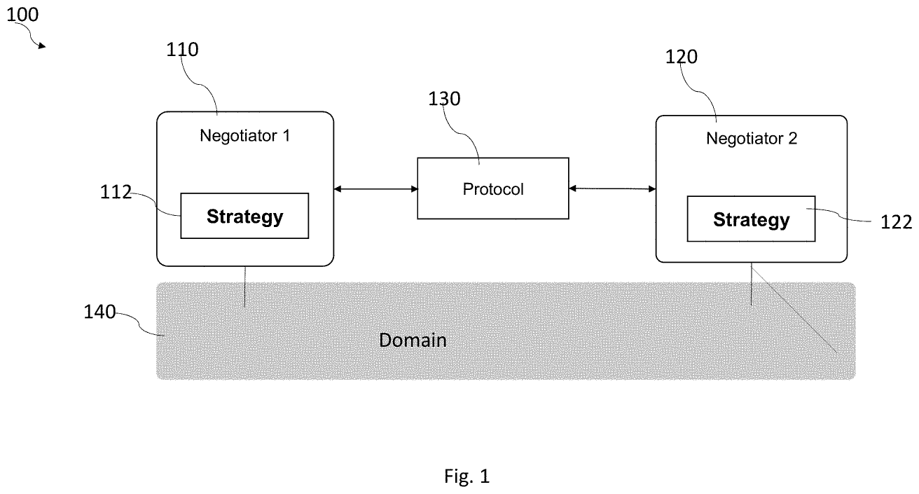

FIG. 1 is a schematic view of a negotiation 100 using an autonomous negotiation method in accordance with some embodiments. The negotiation 100 includes a first negotiator 110 including a first strategy 112. The negotiation 110 includes a second negotiator 120 including a second strategy 122. A protocol 130 is used to determine the style of negotiation between the first negotiator 110 and the second negotiator 120. A domain 140 includes the issues to be resolved in the negotiation 100. The negotiation 100 is a bilateral negotiation. However, the current disclosure is not limited to only bilateral scenarios.

The first negotiator 110 includes AI algorithms for determining priorities for the issues to be resolved. These priorities are captured in utility values associated with each of the issues to be resolved. That first negotiator 110 uses these utility values to prioritize possible outcomes from the negotiation 100. The first negotiator 110 is able to communicate with the second negotiator 120 using the protocol 130. In some embodiments, the first negotiator 110 is able to communicate wirelessly. In some embodiments, the first negotiator 110 is able to communicate using a wired connection. In some embodiments, the first negotiator 110 is able to communicate via the Internet. The first negotiator 110 is able to transmit an offer, counter-offer, acceptance or rejection to the second negotiator 120. The first negotiator 110 is autonomous, i.e., operating without user input or control.

The first strategy 112 is the action determined by the first negotiator 110 based on the utility values and algorithm used by the first negotiator 110. In some embodiments, the first strategy 112 includes an offer, a counter-offer, an acceptance or a rejection. In some embodiments, the first strategy 112 changes during the negotiation 100 based on new information received from the second negotiator 120.

The second negotiator 120 includes AI algorithms for determining priorities, captured using utility values, for the issues to be resolved. The second negotiator 120 is able to communicate with the first negotiator 110 using the protocol 130. In some embodiments, the second negotiator 120 is able to communicate wirelessly. In some embodiments, the second negotiator 120 is able to communicate using a wired connection. In some embodiments, the second negotiator 120 is able to communicate via the Internet. The second negotiator 120 is able to transmit an offer, counter-offer, acceptance or rejection to the first negotiator 110. In some embodiments, hardware for the first negotiator 110 is the same as the hardware for the second negotiator 120. In some embodiments, hardware for the first negotiator 110 is different from the hardware for the second negotiator 120. In some embodiments, the algorithms implemented in the first negotiator 110 are the same as the algorithms implemented in the second negotiator 120. In some embodiments, the algorithms implemented in the first negotiator 110 are different from algorithms implemented in the second negotiator 120. In some embodiments, the second negotiator 120 is autonomous. In some embodiments, the second negotiator 120 is controlled based on user input.

The second strategy 122 is the action determined by the second negotiator 120 based on the utility values and algorithm used by the second negotiator 120. In some embodiments, the second strategy 122 includes an offer, a counter-offer, an acceptance or a rejection. In some embodiments, the second strategy 122 changes during the negotiation 100 based on new information received from the first negotiator 110.

The protocol 130 is the rules for the negotiation 100. For example, in an alternating offers protocol, the negotiators, e.g., the first negotiator 110 and the second negotiator 120, exchange offers in an alternating fashion. In some embodiments, the protocol 130 is an alternating offers protocol. In some embodiments, the protocol 130 is a different protocol, such as time based offers, or other suitable protocols. The protocol 130 is established prior to beginning the negotiation 100 so that the first negotiator 110 and the second negotiator 120 know when and whether an offer or reply should be transmitted. In some embodiments, the protocol 130 includes a maximum number of steps, e.g., offers. In some embodiments, the protocol 130 includes a time limit for the negotiation 100.

The domain 140 includes the issues to be resolved. For example, the issues to be resolved, in some embodiments, include price, quantity, brand name, etc. In some embodiments, the domain 140 includes a single issue. In some embodiments, the domain 140 includes multiple issues. Each of the first negotiator 110 and the second negotiator 120 knows the domain 140 and attributes a utility value to combinations of the issues to be resolved. For example, where the domain 140 includes price and brand name and there are two options for each of price and brand name, the first negotiator 110 will have four different utility values, i.e., one for each possible combination. In some embodiments, the first negotiator 110 and the second negotiator 120 have utility values for less than all possible combinations. In some embodiments, the utility values assigned by the first negotiator 110 are different from the utility values assigned by the second negotiator 120 because the first and second negotiators have different priorities.

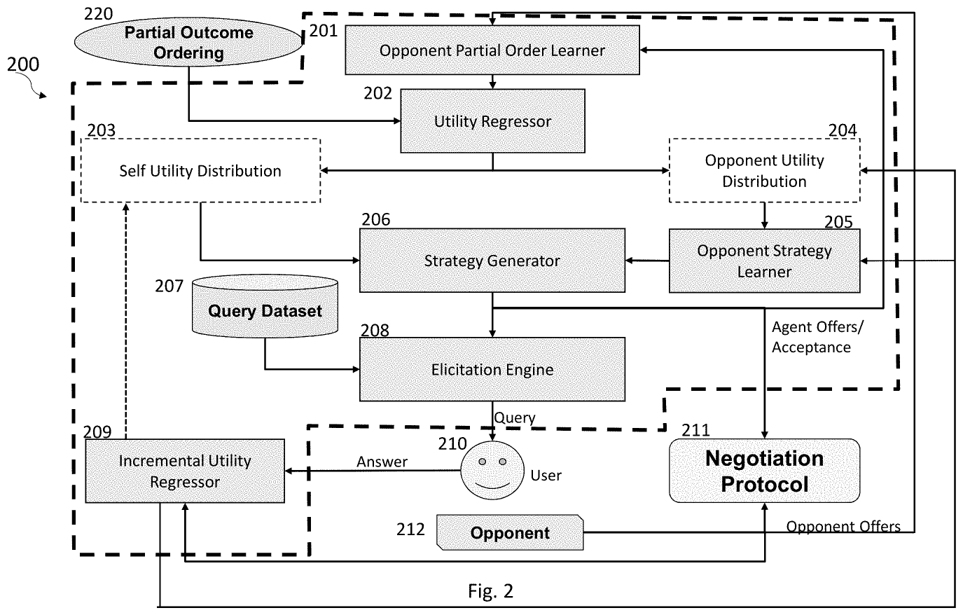

FIG. 2 is a schematic view of a system 200 for determining whether to elicit information from a user in accordance with some embodiments. The system 200 is usable by an AI negotiator to determine whether to elicit additional information from a user 210. The system 200 also determines which additional information to elicit from the user 210 in order to maximize a value of the additional information and minimize interruption of the user 210. The user 210, a negotiation protocol 211 and an opponent 212 are not part of the system 200.

The user 210 is an entity for which the system 200 is used to negotiate. In some embodiments, the user 210 is a human. In some embodiments, the user 210 is an automated device. In some embodiments, the user 210 is similar to the first negotiator 110 in negotiation 100 (FIG. 1).

The negotiation protocol 211 determines how the user 210 and the opponent 212 negotiate with one another. Most of this disclosure is written in contemplation of an alternating offers negotiation protocol 211. However, one of ordinary skill in the art would recognize that they system 200 is applicable to additional negotiation protocols. In some embodiments, the negotiation protocol 211 is similar to the protocol 130 in negotiation 100 (FIG. 1).

The opponent 212 is an opposing party to the user 210 in a negotiation. In some embodiments, the opponent 212 is a human. In some embodiments, the opponent 212 is an automated device. In some embodiments, the opponent 212 is similar to the second negotiator 120 in negotiation 100 (FIG. 1).

The system 200 includes an opponent partial order learner 201 which is configured to determine the strategy of the opponent 212. The opponent partial order learner 201 is configured to receive an offer from the opponent 212. Based on the current offer from the opponent 212 and any previous offers from the opponent 212, the opponent partial order learner 201 is configured to determine a strategy of the opponent 212. The opponent partial order learner 201 is configured to determine priorities and preferences for the opponent 212 in order to determine what combinations of parameters are expected to have a highest value for the opponent 212. The opponent partial order learner 201 is also configured to receive inputs from a strategy generator 205. The strategy generator 205 provides information to the opponent partial order learner 201 in order to assist in determining the value of different combinations of parameters to each of the user 210 and the opponent 212. Based on this information, the system 200 is able to determine which combinations of parameters to offer during the negotiation.

The system further includes a utility regressor 202. The utility regressor 202 is configured to receive information from the opponent partial order learner 201 and a partial outcome ordering 220. The partial outcome ordering 220 includes information regarding preferences and priorities of the user 210. In some embodiments, the information regarding preferences and priorities of the user 210 are received as inputs from the user 210. In some embodiments, the information regarding preferences and priorities of the user 210 are based on results of previous negotiations performed by the system 200. In some embodiments, the partial outcome ordering 220 is included as part of the system 200. In some embodiments, the partial outcome ordering 220 is part of an external device or part of the user 210.

The partial outcome ordering 220 includes a best case result for the user 210 and a worst case result for the user 210 for the current negotiation. The best case result for the user 210 is the combination of parameters which provide the highest possible value to the user 210. The worst case result for the user 210 is the combination of parameters which provide the lowest possible value to the user 210. In some embodiments, the partial outcome ordering 220 additionally includes intermediate case result information that is between the best case result and the worst case result. In some embodiments, the intermediate case result information includes information related to less than 50% of the possible parameter combinations for the negotiation. In some embodiments, the intermediate case result information includes information related to less than 20% of the possible parameter combinations for the negotiation. In some embodiments, the intermediate case result information includes information related to less than 10% of the possible parameter combinations for the negotiation. As the amount of intermediate case information increases, the system 200 is able to more precisely determine the value of each offer or counter-offer to the user 210. As the amount of intermediate case information increases, an amount of time consumed in generating the intermediate case information also increases. That is, an amount of queries requested of the user 210 or a number of simulated negotiations performed by the system 200 increases.

In contrast with other approaches, the system 200 is able to implement a negotiation using the partial outcome ordering 220 which includes very few of the possible combination of parameters. This allows the system 200 to be quickly implemented without interrupting the user 210 and without running numerous simulated negotiations. In addition, the system 200 is sufficiently flexible to be used in negotiations that include new parameters not previously considered by the system 200 with minimal additional information. As a result, the usability of the system 200 is better than other approaches which utilize a larger amount of initial information in order to conduct a negotiation.

The utility regressor 202 is configured to avoid assuming any distribution of values for the different parameters for both the user 210 and the opponent 212. Instead, the utility regressor 202 utilizes the result of the opponent partial order learner 201 and the partial outcome ordering 220 in order to determine the Ufun for the user 210 and the Ufun for the opponent 212. The Ufun for the user 210 is stored in a self utility distribution 203. The Ufun for the opponent 212 is stored in an opponent utility distribution 204. The utility regressor 202 is configured to update the Ufun for the user 210 and the Ufun for the opponent 212 during each iteration of the negotiation. That is, the Ufun for each of the user 210 and the opponent 212 are updated based on the offer and counter offer during each round of the negotiation.

The self utility distribution 203 is configured to store information related to the preferences and priorities of the user 210. In some embodiments, the partial outcome order 220 is initially stored in the self utility distribution 203.

The opponent utility distribution 204 is configured to store information related to the preferences and priorities of the opponent 212. In some embodiments, the opponent utility distribution 204 is configured to retrieve information about the opponent 212 from a previous negotiation with a same opponent 212. In some embodiments, the opponent utility distribution 204 and the self utility distribution 203 are part of a same storage device. In some embodiments, the opponent utility distribution 204 and the self utility distribution 203 are in separate storage devices.

The system 200 further includes an opponent strategy learner 205. The opponent strategy learner 205 is configured to determine a strategy of the opponent 212 being used in the negotiation. The opponent strategy learner 205 is configured to receive information related to determined preferences and priorities for the opponent 212 from the opponent utility distribution 204 and information related to opponent offers from an incremental utility regressor 209, discussed below. Based on the preference and priorities for the opponent and the opponent offers, the opponent strategy learner 205 is configured to estimate how the opponent 212 is expected to perform during future iterations of the negotiation. In some embodiments, the opponent strategy learner 205 is configured to attempt to determine the second strategy 122 of the negotiation 100 (FIG. 1).

The system 200 further includes a strategy generator 206. The strategy generator is configured to receive information regarding the preferences and priorities of the user 210 from the self utility distribution 203 and information related to a strategy of the opponent 212 from the opponent strategy learner 205. The strategy generator 206 is configured to compare the self utility distribution 203 with the estimated strategy of the opponent 212 from the opponent strategy learner 205 in order to determine an offer to be made to the opponent 212. In some embodiments, the strategy generator 206 is configured to determine an offer having the highest value to the user 210, based on the self utility distribution 203, which has a threshold value to be accepted by the opponent 212, based on the opponent strategy learner 205. In some embodiments, the threshold value is predetermined by the user 210. In some embodiments, the threshold value is constant throughout the negotiation. In some embodiments, the threshold value is adjusted during the course of the negotiations. For example, in some embodiments, the threshold value is increased after a predetermined number of iterations in the negotiations. In some embodiments, the strategy generator 206 is configured to require that the offer have at least a minimum value to the user 210 regardless of a likelihood of acceptance by the opponent 212. In some embodiments, the minimum value is predetermined by the user 210. In some embodiments, the minimum value is adjustable by the user 210 during the negotiation.

In response to identification of an offer satisfying the above conditions, the strategy generator 206 sends and offer to the opponent 212 based on the negotiation protocol 211. In response to a failure to identify an offer satisfying the above conditions, the strategy generator 206 sends a signal to an elicitation engine 208 to attempt to gather more information for identifying an offer satisfying the above conditions.

The elicitation engine 208 is configured to receive a request from the strategy generator 206 for additional information regarding preferences and priorities of the user 210. The elicitation engine 208 is configured to retrieve from a query dataset 207 a list of possible queries for the user 210. The elicitation engine 208 is configured to determine which, if any, queries from the query dataset 207 would satisfy the request for additional information from the strategy generator 207.

In response to a determination that multiple queries would satisfy the request for additional information, the elicitation engine 208 is configured to determine which of the at least one queries would have a highest value of information (VOI). The VOI is a measure of how important the answer to the query is in removing uncertainty in the Ufun for the user 210. A higher VOI will have a greater reduction in uncertainty in the Ufun for the user 210. Once the elicitation engine 208 identifies the query having a highest VOI, the elicitation engine compares the VOI of the identified query with an interruption threshold value. In response to a determination that a single query would satisfy the request for additional information, the elicitation engine 208 compares the VOI of the single query with the interruption threshold value.

The interruption threshold value is VOI value used to measure how permissible the user 210 is of interruptions during the negotiation. A lower interruption threshold indicates that the user 210 is more permissible to interruptions. A higher interruption threshold indicates the user 210 is less permissible to interruptions. In some embodiments, the interruption threshold is predetermined by the user 210. In some embodiments, the interruption threshold remains constant through the negotiation. In some embodiments, the interruption threshold changes during the negotiations. For example, in some embodiments, the interruption threshold changes during the negotiation based on an instruction received from the user 210 during the negotiation indicating that the user 210 is now more or less permissible of interruptions. In another example, in some embodiments, the interruption threshold increases automatically as a number of iterations in the negotiation increases. In some embodiments, where the user 210 is a system, the interruption threshold is set based on available processing power within the user 210 at a time the query is identified.

In response to a determination that a query satisfies the request for additional information and the VOI is greater than the interruption threshold value, the elicitation engine 208 sends the query to the user 210. In some embodiments, the interruption threshold includes a single value indicating that the user 210 is permissible of a query. In some embodiments, the interruption threshold includes multiple values indicating how many queries the user 210 would permit. For example, at a first value of the interruption threshold the user 210 would permit a single query; and a second value, higher than the first value, of the interruption threshold, the user would permit two queries. By providing multiple values for the interruption threshold, the system 200 is able to decrease uncertainty in the Ufun for the user 210 using multiple queries having high VOI while also reducing interruptions of the user 210 for low VOI queries. One of ordinary skill in the art would recognize that while the above description provides for two different interruption threshold values more than two interruption threshold values are within the scope of this disclosure.

In response to a determination that no query satisfies the request for additional information and has a VOI greater than the interruption threshold value, the elicitation engine 208 is configured to send a signal to the strategy generator 206 indicating that no additional information is currently available. In response to such a signal from the elicitation engine 208, the strategy generator 206 is configured to issue an offer, acceptance or rejection to the opponent 212 through the negotiation protocol based on the currently available information.

The query dataset 207 includes queries this for the user 210. Instead of queries such as requesting a value of a certain parameter, the queries in the query dataset 207 inquiry about which of two combinations of parameters are preferred by the user 210. For example, in some embodiments, a query in the query dataset 207 includes “Which is preferred, Quantity A purchased at Price P delivered at Time X OR Quantity B purchased at Price R delivered at Time YT” Using this type of comparison based question the user 210 is able to quickly answer the query without having to assign a specific value to Quantity A or Time Y. This helps to minimize interruptions for the user 210 during the negotiation. The query dataset 207 includes every possible combination of parameters for the negotiation so that the elicitation engine 208 is able to retrieve any possible comparison query in order to maximize the value of the outcome of the negotiation for the user 210. In some embodiments, the queries are preloaded onto the query dataset 207 prior to the negotiation. In some embodiments, the queries in the query dataset 207 are generated and stored during the negotiation based on the domain, e.g., domain 140 (FIG. 1), of the negotiation. Having the ability to ask any possible question to the user 210 that satisfies the interruption threshold value helps to maximize the value of the outcome of the negotiation for the user 210.

The system 200 further includes an incremental utility regressor 209 configured to receive answers from the user 210 in response to queries from the elicitation engine 208 and offers from the opponent 212. The incremental utility regressor 209 is configured to update the self utility distribution 203 based on any answers from the user 210; and to update the opponent utility distribution 204 based on offers from the opponent 212. In some embodiments, the incremental utility regressor 209 is also configured to update the opponent strategy in the opponent strategy learner 205 based on the offers from the opponent 212. Unlike the utility regressor 202, the incremental utility regressor 209 is configured to assume some distribution of values for the different parameters for both the user 210 and the opponent 212.

Using the system 200, a negotiation is able to be initiated and conducted with significant uncertainty in the preferences and priorities of the user 210. The system 200 is capable of obtaining additional information from the user 210 during the negotiation without interrupting the user 210 to more than an acceptable degree. In comparison with other approaches, the system 200 has increased flexibility and shorter training time in order to be able to conduct negotiations.

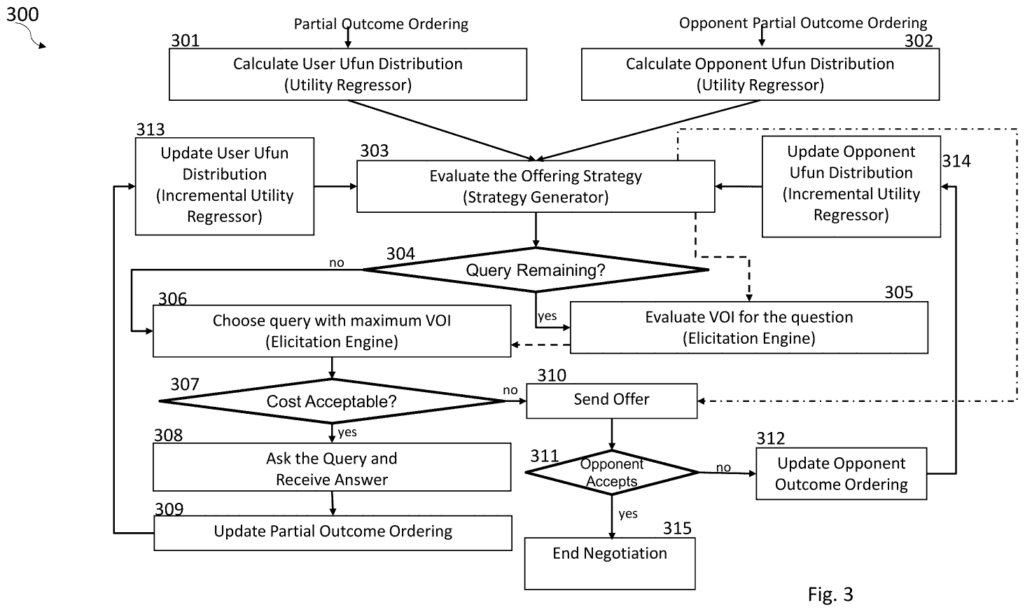

FIG. 3 is a flowchart of a method 300 of negotiating in accordance with some embodiments. In some embodiments, the method 300 is implemented using the system 200 (FIG. 2). In some embodiments, the method 300 is implementing using a system other than the system 200. FIG. 3 includes some components of the system 200 in operation blocks of the method 300. One of ordinary skill in the art would recognize that these components are merely exemplary and do not limit the operations of the method 300 as being implemented by only the mentioned components.

The method 300 includes operation 301 in which a user Ufun distribution is calculated. The user Ufun distribution is calculated based on a partial outcome ordering for the user, e.g., the user 210 (FIG. 2). In some embodiments, the user Ufun distribution is calculated using a utility regressor, e.g., the utility regressor 202 (FIG. 2). In some embodiments, the calculated user Ufun distribution is stored in a self utility distribution, e.g., the self utility distribution 203 (FIG. 2).

The method includes operation 302 in which an opponent Ufun distribution is calculated. The opponent Ufun distribution is calculated based on a partial outcome ordering for the opponent, e.g., the opponent 212 (FIG. 2). In some embodiments, the partial outcome ordering for the opponent is determined using an opponent partial order learner, e.g., the opponent partial order learner 201 (FIG. 2). In some embodiments, the opponent Ufun distribution is calculated using a utility regressor, e.g., the utility regressor 202 (FIG. 2). In some embodiments, the utility regressor used in operation 301 is a same utility regressor used in operation 302. In some embodiments, the utility regressor used in operation 301 is different from the utility regressor used in operation 302. In some embodiments, the calculated opponent Ufun distribution is stored in an opponent utility distribution, e.g., the opponent utility distribution 204 (FIG. 2). In some embodiments, operation 302 is performed simultaneously with operation 301. In some embodiments, operation 302 is performed before or after the operation 301.

In operation 303, an offering strategy is evaluated. The offering strategy is based on the calculated user Ufun distribution and the opponent Ufun distribution. The offering strategy is based on an evaluation of an estimated strategy of the opponent in order to determine an offer to be made to the opponent. In some embodiments, an offer having the highest value to the user, based on the calculated Ufun distribution, that has a threshold value to be accepted by the opponent, based on the opponent Ufun distribution. In some embodiments, the threshold value is predetermined by the user. In some embodiments, the threshold value is constant throughout the negotiation. In some embodiments, the threshold value is adjusted during the course of the negotiations. For example, in some embodiments, the threshold value is increased after a predetermined number of iterations in the negotiations. In some embodiments, the offer has at least a minimum value to the user regardless of a likelihood of acceptance by the opponent. In some embodiments, the minimum value is predetermined by the user. In some embodiments, the minimum value is adjustable by the user during the negotiation.

In some instances, the offering strategy evaluation indicates that additional information would assist in evaluating an offer strategy. In response to determining that additional information should be requested, a signal is generated to request additional information from the user and the method 300 proceeds to operation 304. In response to a determination that no additional information should be requested, the method 300 proceeds to operation 310. In some embodiments, operation 303 is implemented using a strategy generator, e.g., the strategy generator 206 (FIG. 2).

In operation 304, a determination is made regarding whether any possible queries remain that would provide additional information to assist in evaluating the offer strategy. In some embodiments, the determination of whether such a query exists is based on queries stored in a query dataset, e.g., the query dataset 207. In some embodiments, the determination of whether such a query exists is based on a comparison between a proposed offer generated in operation 303 and the available queries. In response to a determination that a query exists that satisfies the above criteria, the method 300 proceeds to operation 305. In response to a determination that a query does not exist that satisfies the above criteria, the method 300 proceeds to operation 306.

In operation 305, the query identified in operation 304 is evaluated to determine the VOI of the query. The VOI is a measure of how important the answer to the query is in removing uncertainty in the Ufun for the user. A higher VOI will have a greater reduction in uncertainty in the Ufun for the user. In some embodiments, the VOI is determined based on the offer generated in operation 303. In some embodiments, multiple queries are identified in operation 304. In response to multiple queries being identified in operation 304, the VOI for each identified query is determined in operation 305.

In operation 306, a query with a maximum VOI is selected. The VOI values are received from the evaluation in operation 305. In some embodiments where no query is identified in operation 304, the query with the highest known VOI is selected in operation 306. In some embodiments, all queries identified in operation 304 are ranked based on the corresponding VOI in operation 306. In some embodiments, when no queries are available that would provide additional information for evaluating the offer strategy, the method 300 proceed from operation 304 to operation 310 without asking a query to the user.

In operation 307, a determination is made regarding whether the interruption of the user is warranted based on the VOI of the query to be asked to the user. The VOI of the identified query is compared with an interruption threshold value. The interruption threshold value is VOI value used to measure how permissible the user is of interruptions during the negotiation. In some embodiments, the interruption threshold is predetermined by the user. In some embodiments, the interruption threshold remains constant through the negotiation. In some embodiments, the interruption threshold changes during the negotiations. For example, in some embodiments, the interruption threshold changes during the negotiation based on an instruction received from the user during the negotiation indicating that the user is now more or less permissible of interruptions. In another example, in some embodiments, the interruption threshold increases automatically as a number of iterations in the negotiation increases. In some embodiments, where the user is a system, the interruption threshold is set based on available processing power within the user at a time the query is identified. In some embodiments, the interruption threshold includes a single value. In some embodiments, the interruption threshold includes multiple values indicating how many queries the user would permit. By providing multiple values for the interruption threshold, the method 300 is able to decrease uncertainty in the Ufun for the user using multiple queries having high VOI while also reducing interruptions of the user for low VOI queries. One of ordinary skill in the art would recognize that while the above description provides for two different interruption threshold values more than two interruption threshold values are within the scope of this disclosure.

In response to a determination that a query to the user is warranted, the method 300 proceeds to operation 308. In response to a determination that a query to the user is not warranted, the method 300 proceeds to operation 310.

In some embodiments, operations 304-307 are implemented using an elicitation engine, e.g., the elicitation engine 208 (FIG. 2).

In operation 308, the query is submitted to the user and an answer is received from the user. In some embodiments, the user is a human. In some embodiments, the user is a system. In some embodiments, the query is submitted to the user wirelessly. In some embodiments, the query is submitted to the user through a wired connection. In some embodiments, an alert, e.g., a visual or audio alert on a mobile terminal, is generated to bring the query to the attention of the user. In some embodiments, the user response is received wirelessly. In some embodiments, the user response is received through a wired connection.

In operation 309, the partial outcome ordering is updated based on the response received from the user.

In operation 310, the offer is sent to the opponent through the negotiation protocol, e.g., the negotiation protocol 211 (FIG. 2). In some embodiments, the offer is sent to the opponent wirelessly. In some embodiments, the offer is sent to the opponent through a wired connection. In some embodiments, an alert, e.g., a visual or audio alert on a mobile terminal, is generated to bring the offer to the attention of the opponent.

In operation 311 a determination is made regarding whether the opponent accepted the offer. In some embodiments, the opponent response is received wirelessly. In some embodiments, the opponent response is received through a wired connection. In response to a determination that the opponent accepted the offer, the method 300 proceeds to operation 315. In response to a determination that the opponent did not accept the offer, the method 300 proceeds to operation 312.

In operation 312, the opponent outcome ordering is updated based on a counter offer received from the opponent. In some embodiments where the opponent response is a rejection or the negotiation is otherwise terminated, such as through the negotiation protocol, the method 300 proceeds to operation 315 following analysis of the response received from the opponent.

In operation 313, the user Ufun distribution is updated based on the updated outcome ordering from operation 309. The updated user Ufun distribution is utilized for further iterations of the negotiations in operation 303. In some embodiments, the updated user Ufun distribution is saved in a self utility distribution. In some embodiments, the user Ufun distribution is updated using an incremental utility regressor, e.g., the incremental utility regressor 209 (FIG. 2).

In operation 314, the opponent Ufun distribution is updated based on the updated outcome ordering from operation 312. The updated opponent Ufun distribution is utilized for further iterations of the negotiations in operation 303. In some embodiments, the updated opponent Ufun distribution is saved in an opponent utility distribution. In some embodiments, the opponent Ufun distribution is updated using an incremental utility regressor, e.g., the incremental utility regressor 209 (FIG. 2). In some embodiments, operation 313 and operation 314 are performed using a same incremental utility regressor. In some embodiments, operation 313 is performed using a different incremental utility regressor from operation 314.

In operation 315, the negotiation ends. In some embodiments, the results of the negotiation are fed back in order to improve future negotiations. In some embodiments, the results of the negotiation are reported to the user wirelessly. In some embodiments, the results of the negotiation are reported to the user using a wired connection. In some embodiments, an alert, e.g., a visual or audio alert on a mobile terminal, is generated to bring the negotiation results to the attention of the user.

In some embodiments, an order of operations of the method 300 is adjusted. For example, in some embodiments, operation 302 is performed prior to operation 301. In some embodiments, at least one operation of the method 300 is omitted. For example, in some embodiments, the operation 304 is omitted. In some embodiments, at least one additional operation is added to the method 300. For example, in some embodiments, the method 300 includes an operation for instructing a display to display a current state of the negotiation.

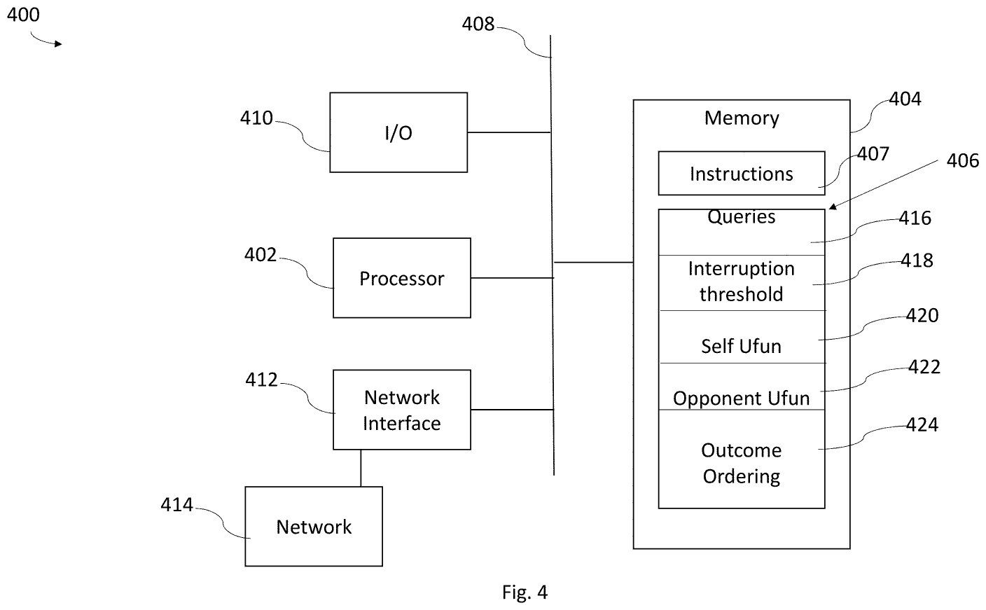

FIG. 4 is a block diagram of a system 400 for implementing a negotiation in accordance with some embodiments. System 400 includes a hardware processor 402 and a non-transitory, computer readable storage medium 404 encoded with, i.e., storing, the computer program code 406, i.e., a set of executable instructions. Computer readable storage medium 404 is also encoded with instructions 407 for interfacing with external devices, such as mobile terminals. The processor 402 is electrically coupled to the computer readable storage medium 404 via a bus 408. The processor 402 is also electrically coupled to an I/O interface 410 by bus 408. A network interface 412 is also electrically connected to the processor 402 via bus 408. Network interface 412 is connected to a network 414, so that processor 402 and computer readable storage medium 404 are capable of connecting to external elements via network 414. The processor 402 is configured to execute the computer program code 406 encoded in the computer readable storage medium 404 in order to cause system 400 to be usable for performing a portion or all of the operations as described in method 300 (FIG. 3) or implementing system 200 (FIG. 2).

In some embodiments, the processor 402 is a central processing unit (CPU), a multi-processor, a distributed processing system, an application specific integrated circuit (ASIC), and/or a suitable processing unit.

In some embodiments, the computer readable storage medium 404 is an electronic, magnetic, optical, electromagnetic, infrared, and/or a semiconductor system (or apparatus or device). For example, the computer readable storage medium 404 includes a semiconductor or solid-state memory, a magnetic tape, a removable computer diskette, a random access memory (RAM), a read-only memory (ROM), a rigid magnetic disk, and/or an optical disk. In some embodiments using optical disks, the computer readable storage medium 404 includes a compact disk-read only memory (CD-ROM), a compact disk-read/write (CD-R/W), and/or a digital video disc (DVD).

In some embodiments, the storage medium 404 stores the computer program code 406 configured to cause system 400 to perform method 300 (FIG. 3) or implementing system 200 (FIG. 2). In some embodiments, the storage medium 404 also stores information needed for performing a method 300 (FIG. 3) or implementing system 200 (FIG. 2) as well as information generated during performing the method 300 (FIG. 3) or implementing system 200 (FIG. 2), such as a queries parameter 416, an interruption threshold parameter 418, a self Ufun parameter 420, an opponent Ufun parameter 422, an outcome ordering parameter 424 and/or a set of executable instructions to perform the operation of method 300 (FIG. 3) or implement system 200 (FIG. 2).

In some embodiments, the storage medium 404 stores instructions 407 for interfacing with external components. The instructions 407 enable processor 402 to generate instructions readable by the external components to effectively implement method 300 (FIG. 3) or system 200 (FIG. 2).

System 400 includes I/O interface 410. I/O interface 410 is coupled to external circuitry. In some embodiments, I/O interface 410 includes a keyboard, keypad, mouse, trackball, trackpad, and/or cursor direction keys for communicating information and commands to processor 402.

System 400 also includes network interface 412 coupled to the processor 402. Network interface 412 allows system 400 to communicate with network 414, to which one or more other computer systems are connected. Network interface 412 includes wireless network interfaces such as BLUETOOTH, WIFI, WIMAX, GPRS, or WCDMA; or wired network interface such as ETHERNET, USB, or IEEE-1394. In some embodiments, method 300 or system 200 is implemented in two or more systems 400, and information is exchanged between different systems 400 via network 414.

An aspect of this description relates to a system. The system includes a non-transitory computer readable medium configured to store instructions thereon. The system further includes a processor connected to the non-transitory computer readable medium. The processor is configured to execute the instructions for receiving information for a user utility function (Ufun) having uncertainty. The processor is further configured to execute the instructions for generating an offer in a negotiation based on the user Ufun. The processor is further configured to execute the instructions for determining whether additional information should be requested from a user. The processor is further configured to execute the instructions for identifying a query to the user to obtain the additional information in response to a determination that additional information should be requested. The processor is further configured to execute the instructions for determining a value of information (VOI) value for the identified query. The processor is further configured to execute the instructions for comparing the VOI value for the identified query with an interruption threshold. The processor is further configured to execute the instructions for sending the identified query to the user in response to the VOI value being greater than the interruption threshold. In some embodiments, the processor is further configured to execute the instructions for sending the generated offer to an opponent in response to a determination that the VOI value of the identified query is less than or equal to the interruption threshold. In some embodiments, the processor is further configured to execute the instructions for updating the user Ufun based on an input from the user in response to the identified query. In some embodiments, the processor is further configured to execute the instructions for receiving an offer from an opponent; and calculating an opponent Ufun based on the received offer from the opponent, wherein the generated offer is generated based on the opponent Ufun. In some embodiments, the processor is further configured to execute the instructions for changing the interruption threshold during the negotiation. In some embodiments, the processor is further configured to execute the instructions for changing the interruption threshold in response to receiving a threshold input from the user. In some embodiments, the processor is further configured to execute the instructions for changing the interruption threshold based on a number of iterations in the negotiation. In some embodiments, the non-transitory computer readable medium is configured to store a plurality of queries, and the processor is further configured to execute the instructions for identifying the query from the plurality of queries. In some embodiments, the processor is further configured to execute the instructions for determining how many queries are permitted to be asked to the user.

An aspect of this description relates to a method. The method includes receiving information for a user utility function (Ufun) having uncertainty. The method further includes generating an offer in a negotiation based on the user Ufun. The method further includes determining whether additional information should be requested from a user. The method further includes identifying a query to the user to obtain the additional information in response to a determination that additional information should be requested. The method further includes determining a value of information (VOI) value for the identified query. The method further includes comparing, using a process, the VOI value for the identified query with an interruption threshold. The method further includes sending the identified query to the user in response to the VOI value being greater than the interruption threshold. In some embodiments, the method further includes sending the generated offer to an opponent in response to a determination that the VOI value of the identified query is less than or equal to the interruption threshold. In some embodiments, the method further includes updating the user Ufun based on an input from the user in response to the identified query. In some embodiments, the method further includes receiving an offer from an opponent; and calculating an opponent Ufun based on the received offer from the opponent, wherein the generated offer is generated based on the opponent Ufun. In some embodiments, the method further includes changing the interruption threshold during the negotiation. In some embodiments, changing the interruption threshold includes changing the interruption threshold in response to receiving a threshold input from the user. In some embodiments, changing the interruption threshold includes changing the interruption threshold based on a number of iterations in the negotiation. In some embodiments, the method further includes storing a plurality of queries, wherein identifying the query comprises identifying the query from the plurality of queries. In some embodiments, the method further includes determining how many queries are permitted to be asked to the user.

An aspect of this description relates to a system. The system includes a non-transitory computer readable medium configured to store instructions thereon. The system further includes a processor connected to the non-transitory computer readable medium. The processor is configured to execute the instructions for receiving information for a user utility function (Ufun) having uncertainty. The processor is further configured to execute the instructions for generating an offer in a negotiation based on the user Ufun. The processor is further configured to execute the instructions for determining whether additional information should be requested from a user. The processor is further configured to execute the instructions for determining a number of queries permitted to be asked to the user based on an interruption threshold. The processor is further configured to execute the instructions for identifying a number of queries to the user to obtain the additional information in response to a determination that additional information should be requested. The processor is further configured to execute the instructions for determining a value of information (VOI) value for each of the identified queries. The processor is further configured to execute the instructions for determining a set of queries to be sent to the user based on the VOI for each of the identified queries and the interruption threshold, wherein a number of queries in the set of queries is equal to or less than the number of queries permitted. The processor is further configured to execute the instructions for sending each of the set of queries to the user. In some embodiments, the processor is configured to execute the instructions for changing the interruption threshold during the negotiation.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A system comprising:
a non-transitory computer readable medium configured to store instructions thereon; and
a processor connected to the non-transitory computer readable medium, wherein the processor is configured to execute the instructions for:
receiving information for a user utility function (Ufun) having uncertainty;
generating an offer in a negotiation based on the user Ufun;
determining whether additional information should be requested from a user;
identifying a query to the user to obtain the additional information in response to a determination that additional information should be requested;
determining a value of information (VOI) value for the identified query;
comparing the VOI value for the identified query with an interruption threshold; and
sending the identified query to the user in response to the VOI value being greater than the interruption threshold.

2. The system according to claim 1, wherein the processor is further configured to execute the instructions for sending the generated offer to an opponent in response to a determination that the VOI value of the identified query is less than or equal to the interruption threshold.

3. The system according to claim 1, wherein the processor is further configured to execute the instructions for updating the user Ufun based on an input from the user in response to the identified query.

4. The system according to claim 1, wherein the processor is further configured to execute the instructions for:
receiving an offer from an opponent; and
calculating an opponent Ufun based on the received offer from the opponent, wherein the generated offer is generated based on the opponent Ufun.

5. The system according to claim 1, wherein the processor is further configured to execute the instructions for changing the interruption threshold during the negotiation.

6. The system according to claim 5, wherein the processor is further configured to execute the instructions for changing the interruption threshold in response to receiving a threshold input from the user.

7. The system according to claim 5, wherein the processor is further configured to execute the instructions for changing the interruption threshold based on a number of iterations in the negotiation.

8. The system according to claim 1, wherein the non-transitory computer readable medium is configured to store a plurality of queries, and the processor is further configured to execute the instructions for identifying the query from the plurality of queries.

9. The system according to claim 1, wherein the processor is further configured to execute the instructions for determining how many queries are permitted to be asked to the user.

10. A method comprising:
receiving information for a user utility function (Ufun) having uncertainty;
generating an offer in a negotiation based on the user Ufun;
determining whether additional information should be requested from a user;
identifying a query to the user to obtain the additional information in response to a determination that additional information should be requested;
determining a value of information (VOI) value for the identified query;
comparing, using a process, the VOI value for the identified query with an interruption threshold; and
sending the identified query to the user in response to the VOI value being greater than the interruption threshold.

11. The method according to claim 10, further comprising sending the generated offer to an opponent in response to a determination that the VOI value of the identified query is less than or equal to the interruption threshold.

12. The method according to claim 10, further comprising updating the user Ufun based on an input from the user in response to the identified query.

13. The method according to claim 10, further comprising:
receiving an offer from an opponent; and
calculating an opponent Ufun based on the received offer from the opponent, wherein the generated offer is generated based on the opponent Ufun.

14. The method according to claim 10, further comprising changing the interruption threshold during the negotiation.

15. The method according to claim 14, wherein changing the interruption threshold comprises changing the interruption threshold in response to receiving a threshold input from the user.

16. The method according to claim 14, wherein changing the interruption threshold comprises changing the interruption threshold based on a number of iterations in the negotiation.

17. The method according to claim 10, further comprising storing a plurality of queries, wherein identifying the query comprises identifying the query from the plurality of queries.

18. The method according to claim 10, further comprising determining how many queries are permitted to be asked to the user.

19. A system comprising:
a non-transitory computer readable medium configured to store instructions thereon; and
a processor connected to the non-transitory computer readable medium, wherein the processor is configured to execute the instructions for:
receiving information for a user utility function (Ufun) having uncertainty;
generating an offer in a negotiation based on the user Ufun;
determining whether additional information should be requested from a user;
determining a number of queries permitted to be asked to the user based on an interruption threshold;
identifying a number of queries to the user to obtain the additional information in response to a determination that additional information should be requested;
determining a value of information (VOI) value for each of the identified queries;
determining a set of queries to be sent to the user based on the VOI for each of the identified queries and the interruption threshold, wherein a number of queries in the set of queries is equal to or less than the number of queries permitted; and
sending each of the set of queries to the user.

20. The system according to claim 19, wherein the processor is configured to execute the instructions for changing the interruption threshold during the negotiation.
